(19) United States
(12) Patent Application Publication
(10) Pub. No.: US 2015/0129600 A1
(43) Pub. Date: May 14, 2015

(54) NON SPILL PAINT CONTAINER LID FOR PAINT BRUSH

(71) Applicants: Kerri Akers, Tucson, AZ (US); Eric Akers, Tucson, AZ (US)

(72) Inventors: Kerri Akers, Tucson, AZ (US); Eric Akers, Tucson, AZ (US)

(21) Appl. No.: 14/076,194

(22) Filed: Nov. 9, 2013

(51) Int. Cl. B44D 3/12

(52) U.S. Cl. CPC B44D 3/127; B44D 3/128
USPC 220/700

(57) ABSTRACT

A combination lid and brush wiping device for use with paint containers having a bi-directional opening. The lid has a brush dipping aperture that allows for a paintbrush to be dipped into the paint container, turned, and upon the act of removing the paint brush from the container, removing the excess paint from the brush. The lid has a second piece that snaps onto the first piece for storage purposes, further creating a semi-permanent multi-functional paint container cover and lid.

### CROSS-REFERENCE TO RELATED APPLICATIONS

Not Applicable

### RELATED REFERENCES CITED

### Related U.S. Patent Documents

U.S. Pat. No. 3,945,527

U.S. Pat. No. 4,275,818

U.S. Pat. No. 5,297,695

U.S. Pat. No. 5,626,258

U.S. Pat. No. 5,662,242

U.S. Pat. No. 5,893,489

U.S. Pat. No. 6,126,048

U.S. Pat. No. 6,213,329

U.S. Pat. No. 6,539,991

U.S. Pat. No. 6,681,952

U.S. Pat. No. 6,820,848

U.S. Pat. No. 7,726,510

U.S. Pat. No. 7,909,201

U.S. Pat. No. 8,087,554

### Related U.S. Patent Applications

US2010/0089931

### Related Foreign Patent Documents

GB2454930

### STATEMENT REGARDING FEDERALLY SPONSORED RESEARCH OR DEVELOPMENT

Not Applicable

### BACKGROUND OF THE INVENTION

1. Field of the Invention

An embodiment of the present invention relates generally to lids for paint containers. More specifically, an embodiment of the present invention relates to such lids with an opening that allows for dipping a paintbrush and wiping off the excess paint when removing the brush, thus preventing any spilled paint. An embodiment of the present invention allows for variations in sizes of paint containers.

2. Background

Paint containers are generally available in gallon and quart sizes, however, there are also smaller sizes available. Paint containers are commonly made of tin coated steel and come with a lid that matches the full diameter of the can.

The same paint cans are generally available at home improvement stores and are used for both commercial and residential painting, and further used by both professional painters and the casual individual painter.

As is well known by those skilled in the art, painting typically is an inherently messy operation. It is a common practice by painters, to engage in a three-stage procedure while painting. First, the painter dips a paint brush into a paint can to deposit an adequate quantity of paint on the paint brush bristles. Second, the painter removes excess paint from the bristles by dragging the bristles—on both sides of the brush—over an edge of the can; this action requires the painter to turn the brush over and wipe off the excess paint two times. Third, the painter performs the painting operation with the usual associated paint waste and mess.

It is also well known in the art that paint cans are routinely constructed with a concentric groove atop the can for snugly receiving a friction lid. The lid is, in turn, constructed with a combination of a lip and trough configured to be received by corresponding paint can grooves that assure the securable closure of the paint container. While engaging in normal painting activities, a painter unavoidably causes paint to fall into this groove or trough during the brush-dragging process, which strives to remove excess paint from the bristles. Inevitably, particularly while painting for protracted periods of time, this trough will become saturated with paint, thereby causing further incursion of excess paint to be deposited upon the sides of the paint container and then communicated to adjacent surfaces and objects. This excess paint accumulation also interferes with the seal of the lid on the paint container.

Past attempts to solve these problems include both pouring the paint from the container to a smaller container for painting, which may still exhibit the same spillage problems, or placing an insert into the paint container to alleviate the spillage problem, however, the action of “double wiping” still exists, and further, the insert in the paint container must be removed when painting is finished the paint container is prepared for storage.

A number of attachments have been proposed that mount on original paint cans. There are several pour spouts designed to facilitate pouring paint from the original container into a rolling pan or other paint container. There are also devices for brush wiping or for resting the brush on the paint container when not painting. There does not exist in prior art a semi-permanent cover for a paint container that provides brush wiping, as well as a lid that fits securely on the cover piece.

An embodiment of the present invention provides for a newly designed paint container cover and lid that overcomes the above-mentioned disadvantages of the current method of painting from a container

Accordingly there is an unaddressed need in the industry to address the aforementioned deficiencies and inadequacies.

### SUMMARY OF THE INVENTION

In preferred embodiments of the present invention, a new cover and lid is provided for paint containers to improve the method of painting by decreasing the time spent wiping excess paint from the paintbrush after dipping the paintbrush in the container.

Another object of the invention is to replace the paint container lid with a new lid that provides several novel functions.

Another object of this invention is to provide a reusable brush wiping device which has no moving parts.

One novel embodiment of the invention is to provide a paint container cover with an opening for dipping the brush in the paint while over half of the surface area of the paint container is covered which provides less spillage while moving the paint container by hand.

Another novel embodiment of the invention is the design of the paint container cover promotes wiping off the excess paint on both sides of the paintbrush when removing the brush from the paint container: this function speeds up the process of preparing the brush for painting.

Another novel embodiment of the invention is an angled surface of the top that promotes the flow of excess paint back into the paint container, which both prevents spilling paint or dripping paint on the sides of the paint container, and saving more paint for use in the container.

Another object of the present invention is to prevent paint from collecting in the paint can rim channel.

Another novel embodiment of the invention is that the two piece cover/lid provides for keeping the brush dipping piece of the cover securely affixed on the outside of the paint container for the life of the paint container, and the second piece of the lid seals on the top in a similar fashion to current paint lids so the container is sealed and the paint is not exposed to air.

Another novel embodiment of the invention is the design may incorporate different materials, such as tin-coated steel, most commonly used in standard paint container tops today, or plastic, while providing the same novel improvements and functions.

Another embodiment of this invention is to provide a brush wiping device which is easy to manufacture and economical to produce.

Still further, another embodiment of this invention is to provide a brush wiping device that can be easily attached to an industry standard one-gallon paint container or one-quart paint container.

In another embodiment of this invention, the brush wiping device may be fit onto a new paint container without the need to empty any of the liquid paint contents to create room.

In another embodiment of the invention, the device and lid may be manufactured of tin coated aluminum or thermoplastic elastomer.

### BRIEF DESCRIPTION OF THE SEVERAL VIEWS OF THE DRAWINGS

The above and other objects, features, and advantages of the present invention are further described in the detailed description which follows, with reference to the drawings by way of non-limiting exemplary embodiments of the present invention, wherein like reference numerals represent similar parts of the present invention throughout the several views and wherein:

FIG. 1 is a top view of the cover

FIG. 2 is a side view of the cover

FIG. 3 is a view of a rib of the inside cover

FIG. 4 is a view of the inner surface and side view of rib

FIG. 5 shows the angled surface of the lid for excess paint to flow back into paint container.

FIG. 6 is a top view of the lid

FIG. 7 is a side view of the lid

FIG. 8 is a top view of the lid shown snapping onto the cover

FIG. 9 is a 3 dimensional rendering of the cover

FIG. 10 is a top view of the quart size cover

FIG. 11 is a side view of the quart size cover

FIG. 12 is a view of a rib of the inside quart size cover

FIG. 13 is a view of the inner surface and side view of a rib of the quart size cover

FIG. 14 shows the angled surface of the lid for excess paint to flow back into paint container of a quart size cover

FIG. 15 is a top view of the lid of the quart size cover

FIG. 16 is a side view of the lid of the quart size cover

FIG. 17 is a top view of the lid snapping onto the quart size cover

FIG. 18 is a 3 dimensional rendering of the quart size cover.

### DETAILED DESCRIPTION OF PREFERRED EMBODIMENTS OF THE INVENTION

Although the detailed description herein contains many specifics for the purposes of illustration, anyone of ordinary skill in the art will appreciate that many variations and alterations to the following details are within the scope of the embodiments described herein. Thus, the following illustrative embodiments are set forth without any loss of generality to, and without imposing limitations upon, the claimed invention.

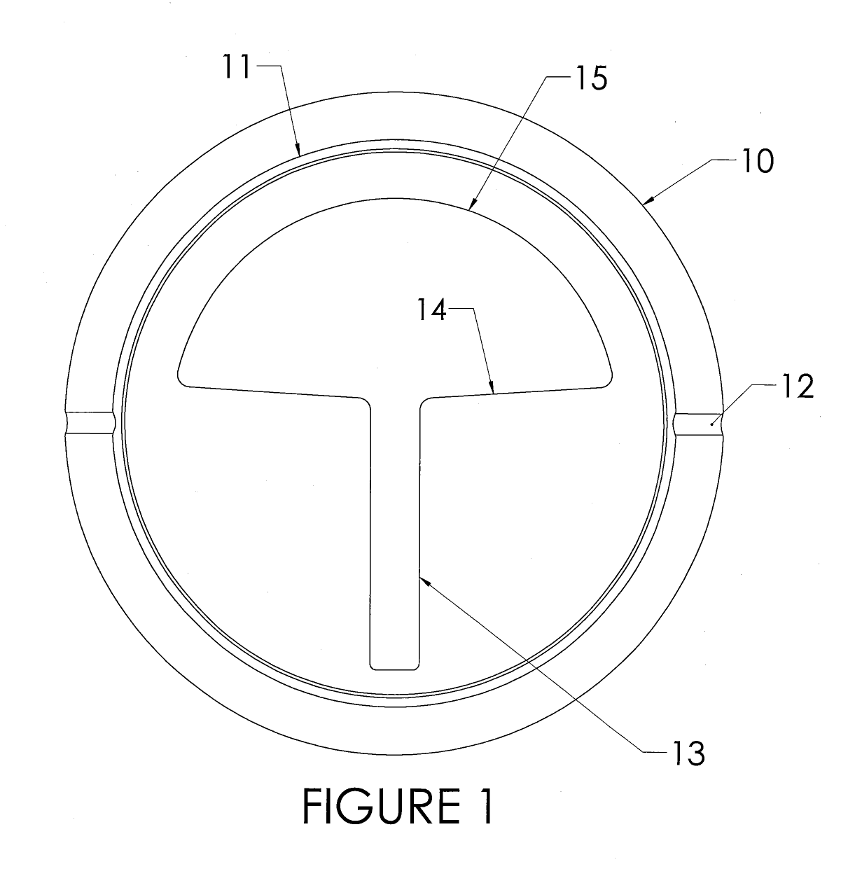

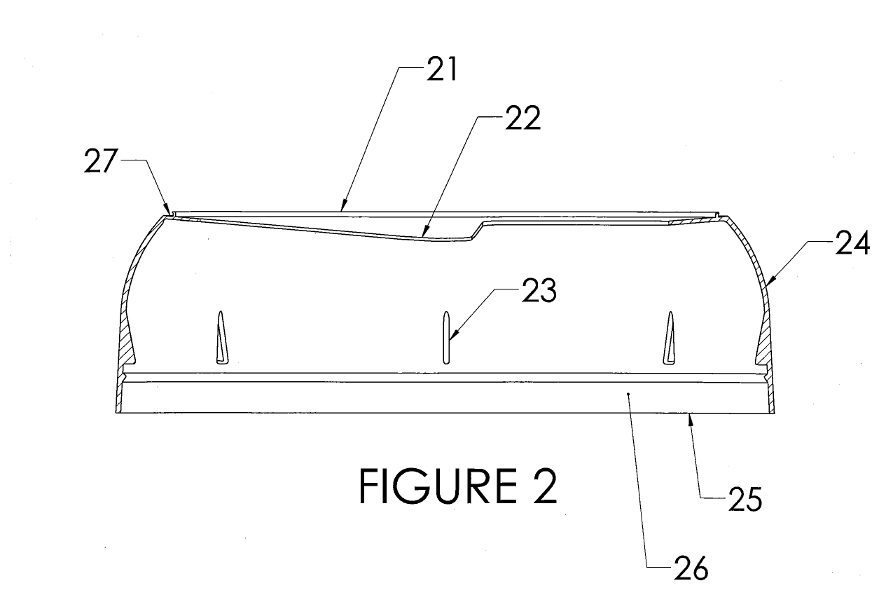

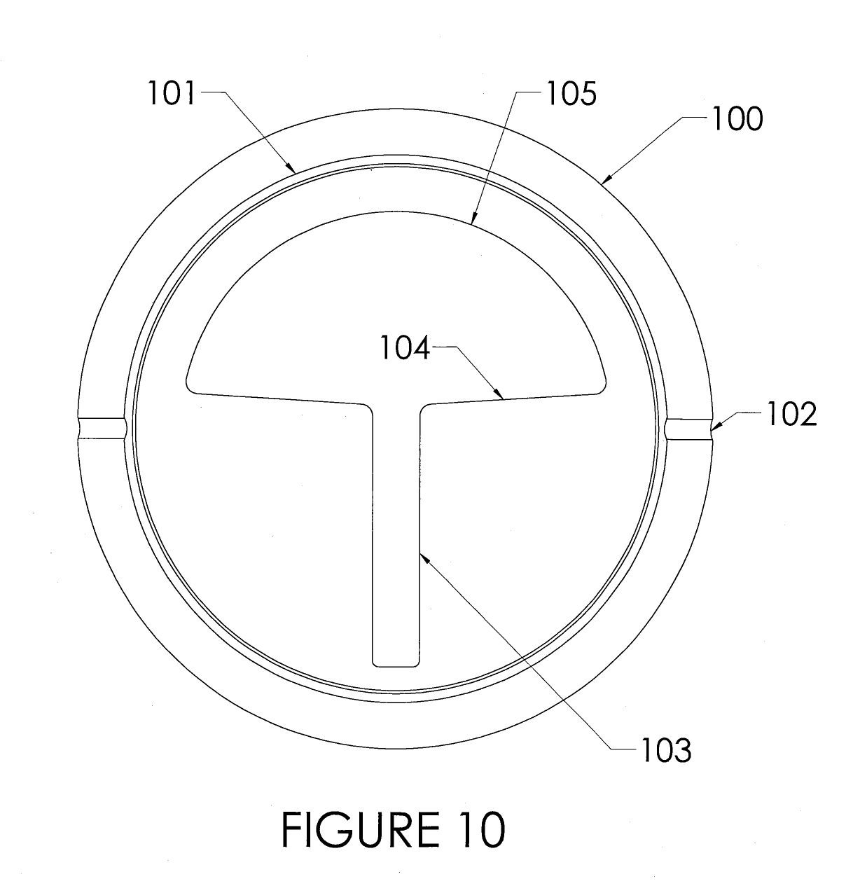

Referring to FIGS. 1 and 10, a paint container cover is shown in the form of a cylindrically shaped, paint can. The container can be a one-gallon paint can as shown in FIG. 1, a quart size paint can as shown in FIG. 2, or any other desired size. A clearance aperture 15 105, has a radius of 2.281 inches (gallon) or 1.468 inches (quart). The width of the paint scraper 13, 103, is 0.5 inches (gallon) or 0.322 inches (quart); the distance from the center line of the bottom edge of the paint scraper 13, 103, is 2.5 inches (gallon) or 1.609 inches (quart). The lid 11, 101 snaps onto the cover. Clearance cuts 12, 102 are for the paint bucket handle to lock into place, has a radius of 0.313 inches (gallon) or 0.201 inches (quart). The edge of the aperture 14, 104, can also be used as a paint scraper to remove excess paint. The outside diameter of the cover 10, 100 is 6.713 inches (gallon) or 4.319 inches (quart). The paint container cover is securely fitted onto the outside of a paint container. The cover can be fitted onto a new paint container without the need to remove any paint from a new container.

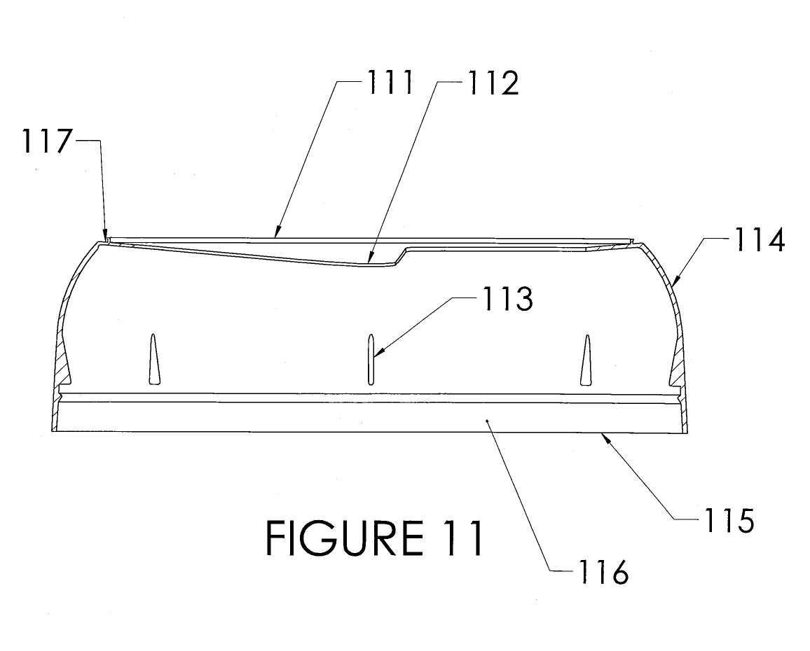

Referring to FIGS. 2 and 11, the lip for the lid to snap on is shown as 21 and 111. The surface of the cover is angled 22, 112 with a 5 degree angle for excess paint to drain back into the container. Ribs 23, 113, are on the cover to help the cover snap onto the paint bucket and remain secure. The outer surface of the cover 24, 114, has an overall height of 2.041 inches (gallon) or 1.314 inches (quart), and a height from the bottom to the top excluding the lip, 21, 112 of 2 inches (gallon) or 1.287 inches (quart). Clearance for the bucket handle 27, 117 is 1.5 inches (gallon) or 0.965 inches (quart). The diameter of the inner surface 26, 116 is 6.32 inches (gallon) or 4.182 inches (quart).

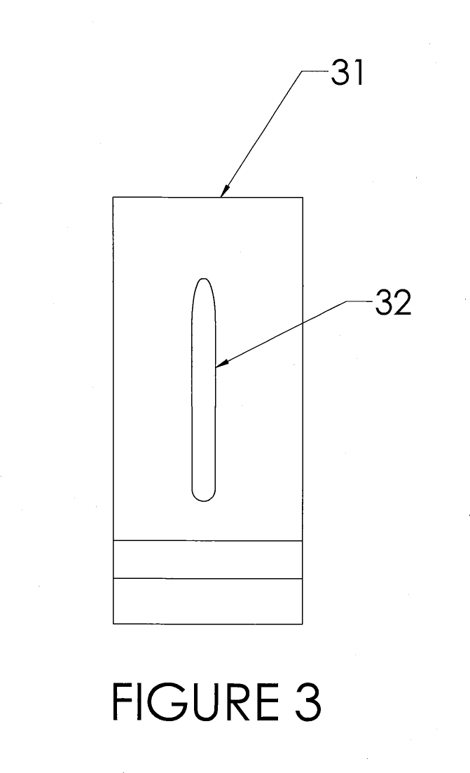

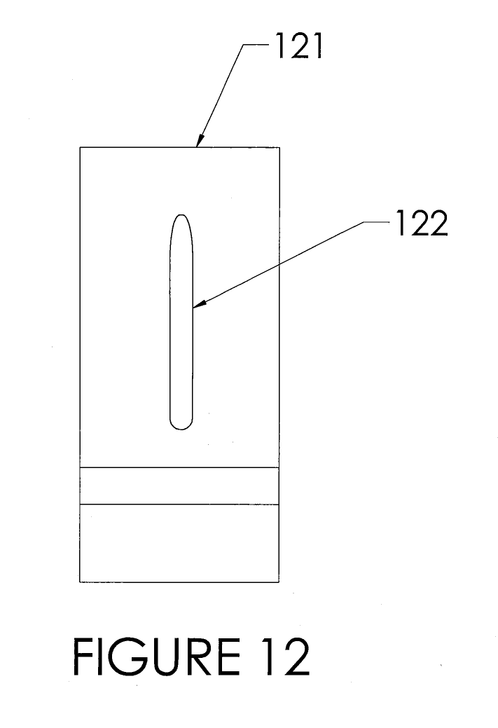

Referring to FIGS. 3 and 12, a view of the surface the rib lies on 31, 121, and a direct view of the rib 32, 122 is shown.

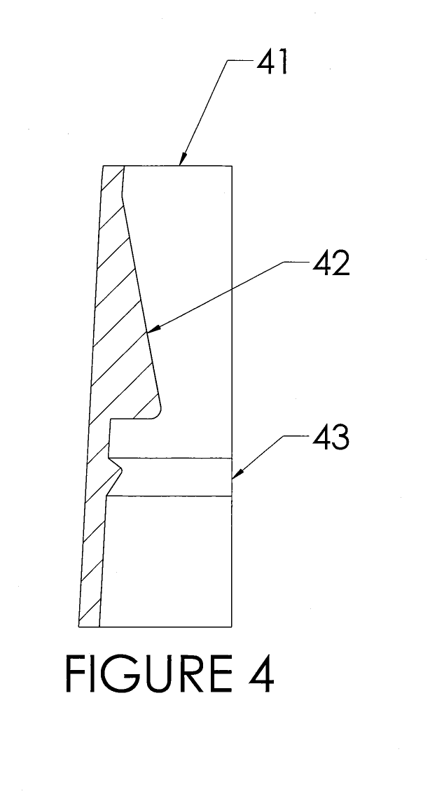

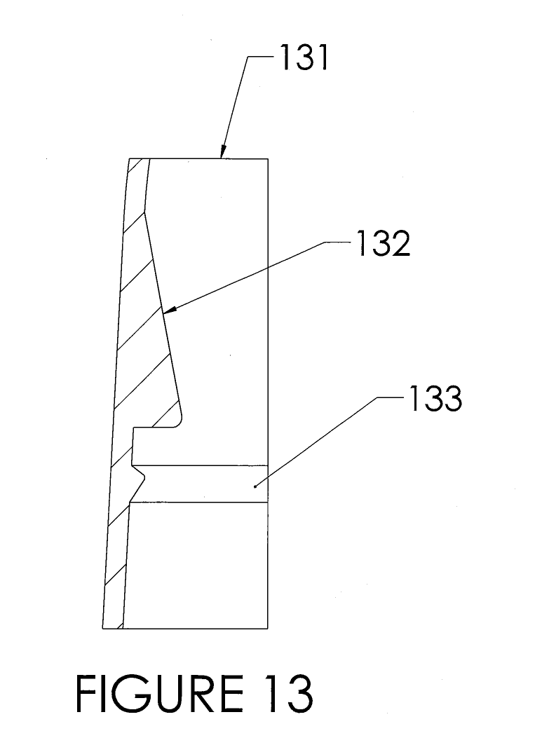

Referring to FIGS. 4 and 13, The inner surface 41, 131 is shown with a side view of the ribs 42, 132, and a lip 43, 133 to help snap the cover onto the paint container.

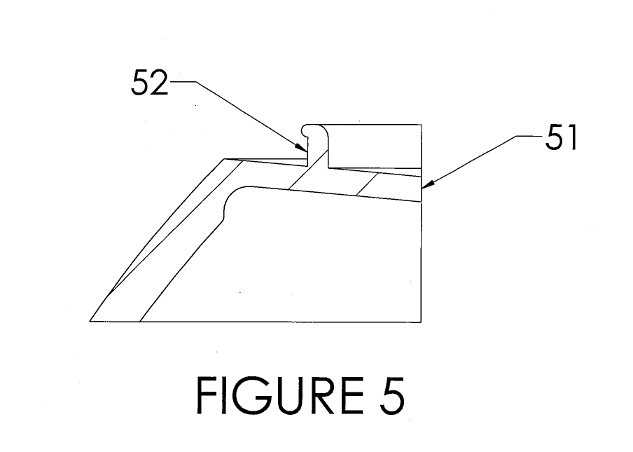

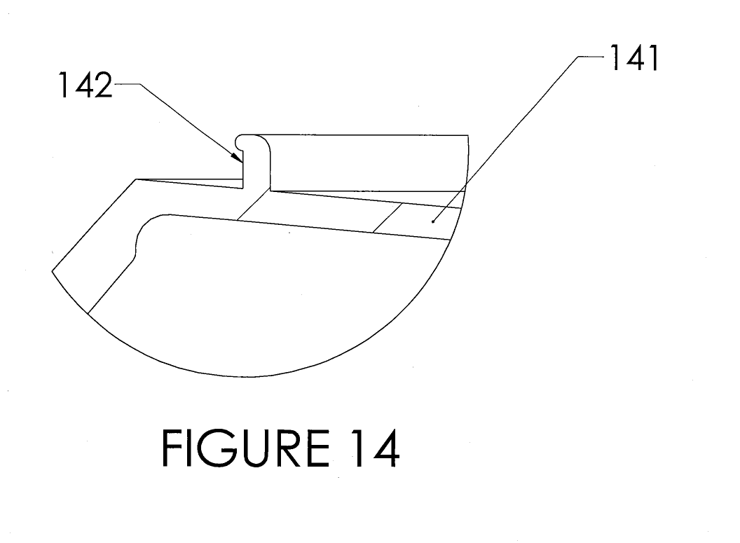

Referring to FIGS. 5 and 14, a view is shows of the angled surface 51, 141 for excess paint to flow back into the paint container, and the lip 52, 142 to snap on the lid.

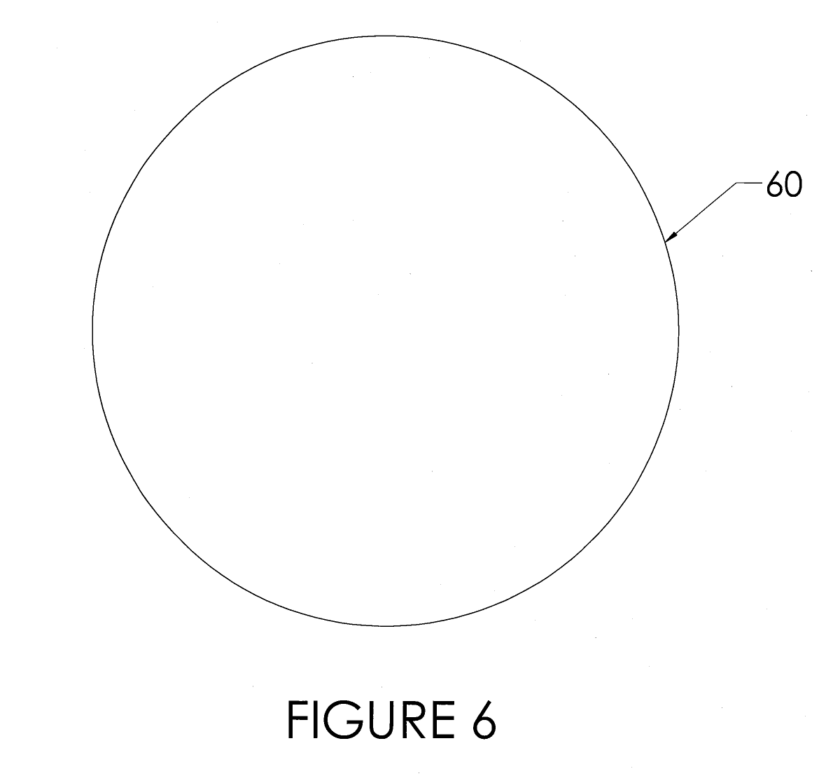

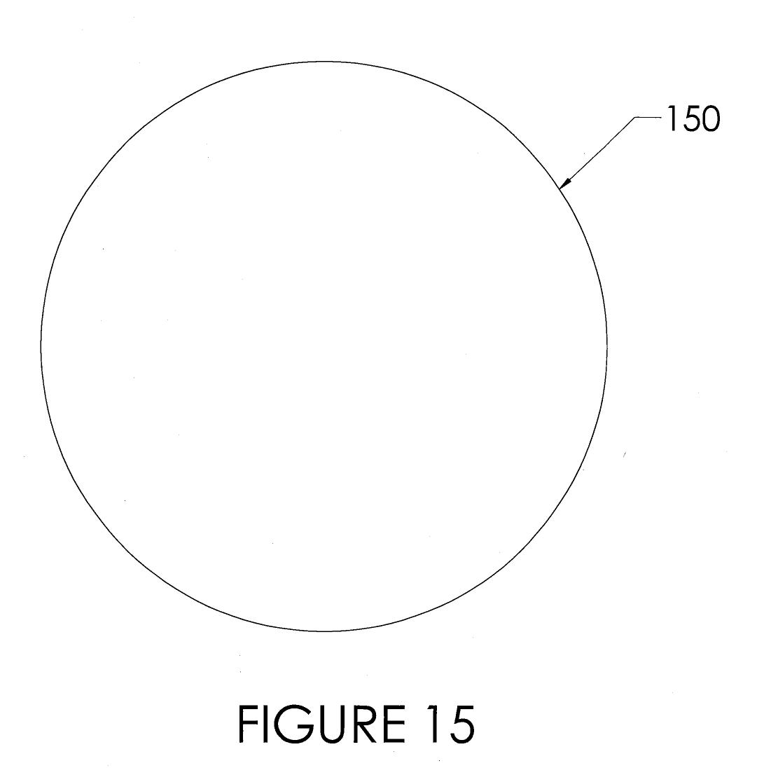

Referring to FIGS. 6 and 15, the top face of the lid is shown. The outside diameter of the lid 60, 150, has a diameter of 5.628 inches (gallon) or 3.621 inches (quart).

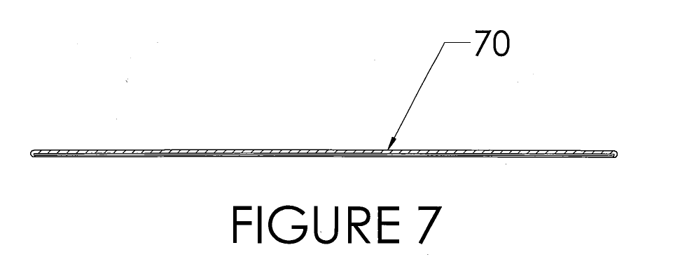

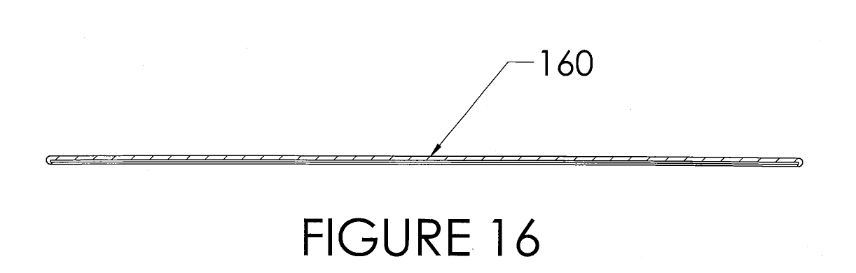

Referring to FIGS. 7 and 16, a side view of the lid 70, 160 is shown.

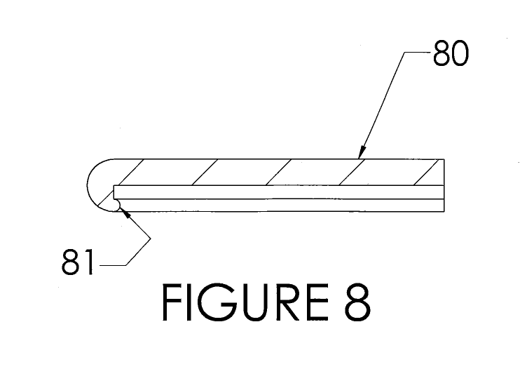

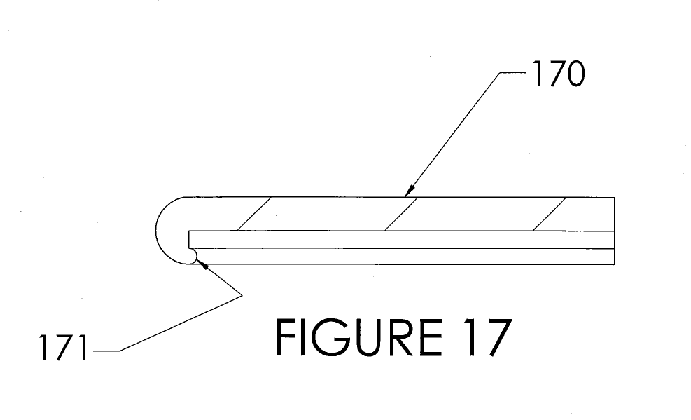

Referring to FIGS. 8 and 17, a top view of the lid 80, 170, is shown with the lip 81, 171 to snap onto the cover. The height of the lid is 0.63 inches (gallon) or 0.40 inches (quart). The radius of the lip is 0.0075 inches (gallon) or 0.0048 inches (quart).

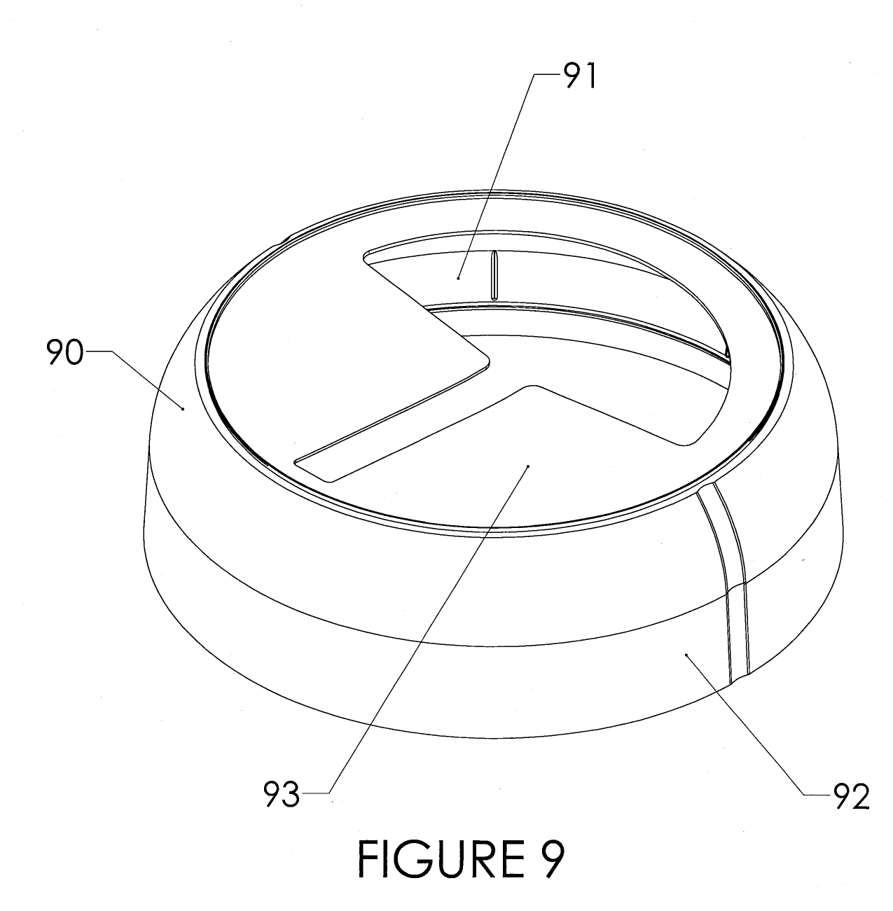

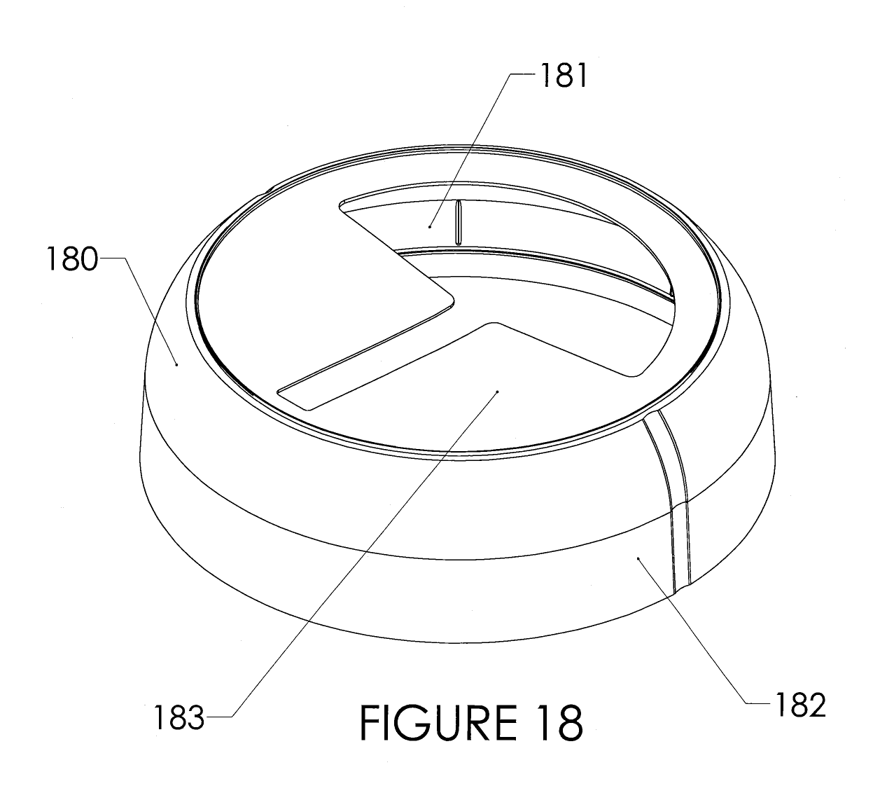

Referring to FIGS. 9 and 18, a three dimensional view of the cover is shown. Clearance for the bucket handles 90, 180, inner surface 91, 181, outer surface 92, 182, and top angled surface 93, 183 are all shown.

1. A brush wiping device that can be attached to an upper surface of a container, said container capable of housing a fluid, said brush wiping device comprising: a one-piece device insertable device into said container; a brush dipping aperture; a brush wiping aperture; and a lid that fits onto said one-piece insertable device.

2. The one-piece insertable device as described in claim 1 is manufactured to fit snugly in a industry standard one-gallon paint container, a industry standard one-quart paint container, or any other custom sized paint container.

3. The one-piece insertable device as described in claim 1 further comprises: a brush dipping arcuate aperture cut-out of the top section.

4. The brush dipping aperture as described in claim 1 is purposed for inserting or dipping a paint brush into a paint container.

5. The one-piece insertable device as described in claim 1 further comprises: a brush wiping aperture vertically positioned below the brush dipping aperture.

6. The brush wiping aperture as described in claim 1 is purposed for removing a paintbrush and wiping excess paint off said paintbrush, and further comprises wiping excess paint off both sides of said paintbrush at the same time.

7. The one-piece insertable device as described in claim 1 further comprises: an angled surface wherein excess paint left on the surface will flow down the angled surface through the aperture back into the paint can.

8. The lid of as described in claim 1 further comprises: a solid round lid designed to snap onto the brush wiping device and further designed to hermetically seal the paint container.

9. The one-piece insertable device as described in claim 1 may be manufactured of tin coated aluminum or thermoplastic elastomer.

10. The lid as described in claim 1 may be manufactured of tin coated aluminum or thermoplastic elastomer; and further is manufactured of the same material as the one-piece insertable device.
